(19) United States
(12) Patent Application Publication
(10) Pub. No.: US 2026/0099486 A1
(43) Pub. Date: Apr. 9, 2026

(54) ENHANCING INTERACTIONS WITH APPLICATIONS USING GENERATIVE AI

(71) Applicant: SAP SE, Walldorf (DE)

(72) Inventors: Jinchi Lu, Mannheim (DE); Ulrich Miller, Schwetzingen (DE)

(21) Appl. No.: 18/910,518

(22) Filed: Oct. 9, 2024

(51) Int. Cl. G06F 16/242; G06F 40/20

(52) U.S. Cl. CPC G06F 16/243; G06F 40/20

(57) ABSTRACT

As discussed herein, users provide natural language requests that are translated into application-specific events. An operations mapping table defines the operations that are provided by the application. A system prompt for a large language model (LLM) is generated based on the operations mapping table. A user prompt for the LLM is generated based on natural language input from a user. The system prompt and the user prompt are provided to the LLM. In response, the LLM generates structured data that is used to invoke one or more operations of the application. By using the systems and methods herein, a computing system providing a user interface for an application is improved by allowing users to interact with the application using natural language inputs.

### TECHNICAL FIELD

The subject matter disclosed herein generally relates to user interactions with applications, and more specifically, to enhancing user interactions with applications by using large language models (LLMs).

### BACKGROUND

Users interact with applications using predefined user interfaces. For example, a data retrieval or processing application may provide a user interface that requires the user to select options or enter values into input fields. The application responds to the user's request based strictly on the correspondence between the input fields and the user's selections or inputs.

Generative artificial intelligence (AI), including LLMs, uses neural networks to generate output. The generated output may include text, images, or video.

### BRIEF DESCRIPTION OF THE DRAWINGS

FIG. 1 shows a network diagram illustrating an example network environment suitable for enhancing user interactions with applications by using generative AI.

FIG. 2 shows a block diagram of an application server, suitable for enhancing user interactions with applications by using generative AI.

FIG. 3 is a block diagram of a neural network, suitable for use as a generative AI for enhancing user interactions with applications, according to some example embodiments.

FIG. 4 illustrates a data flow for a generative AI being used to enhance user interactions with an application, according to some example embodiments.

FIG. 5 shows an illustration of a user interface suitable for enhanced user interaction with an application, according to some example embodiments.

FIG. 6 shows an illustration of a user interface suitable for displaying results from an application, according to some example embodiments.

FIG. 7 illustrates an example database schema, suitable for use in enhancing user interactions with applications by using generative AI.

FIG. 8 illustrates a flowchart for a method of enhancing user interactions with applications by using generative AI, according to some example embodiments.

FIG. 9 shows a block diagram showing one example of a software architecture for a computing device.

FIG. 10 shows a block diagram of a machine in the example form of a computer system within which instructions may be executed for causing the machine to perform any one or more of the methodologies discussed herein.

### DETAILED DESCRIPTION

Example methods and systems are directed to enhancing user interactions with applications by using generative AI. Typically, users interact with applications by clicking with a mouse or entering values into input fields, rather than communicating in natural language.

However, using natural language could allow users without expert knowledge to use an application. Additionally, submitting a request using natural language could take less time and effort as compared to clicking in multiple fields, selecting from various options, and so on. Also, the system may proceed more efficiently by correctly processing a natural language instruction once rather than checking for errors and repeatedly prompting a user to correct form-based submissions.

As discussed herein, users provide natural language requests that are translated into application-specific events. An operations mapping table defines the operations that are provided by the application. A system prompt for an LLM is generated based on the operations mapping table. A user prompt for the LLM is generated based on natural language input from a user. The system prompt and the user prompt are provided to the LLM. In response, the LLM generates structured data that is used to invoke one or more operations of the application. By using the systems and methods herein, a computing system providing a user interface for an application is improved by allowing users to interact with the application using natural language inputs.

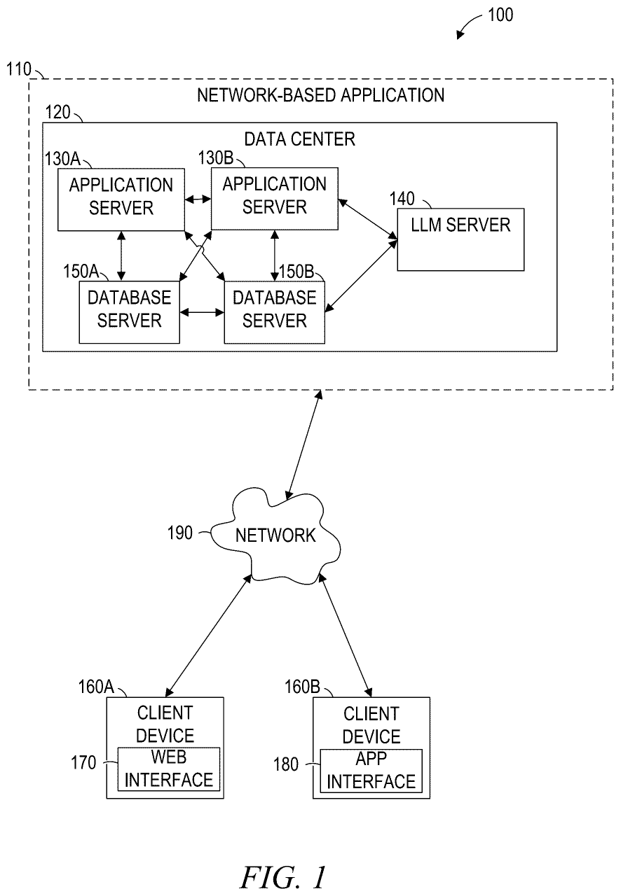

FIG. 1 shows a network diagram illustrating an example network environment 100 suitable for enhancing user interactions with applications by using generative AI. The network environment 100 includes a network-based application 110, client devices 160A and 160B, and a network 190. The network-based application is implemented at a data center 120 that comprises application servers 130A and 130B in communication with database servers 150A and 150B and an LLM server 140. The letter suffixes of reference numbers may be omitted when doing so does not raise ambiguity. For example, the client devices 160A-160B may be referred to collectively as “client devices 160.” Similarly, when the specific one of the client devices 160A-160B is not of particular import, “client device 160” may be referenced.

An application executing on the application servers 130A or 130B may access data from the database servers 150A and 150B. The network-based application 110 may provide a user interface that allows a user to store or retrieve data from the database servers 150. The user interface may be provided to the user via a web interface 170 (e.g., by generating a hypertext markup language (HTML) page at the server and sending it to a web browser to render on a display device) or an application interface 180 (e.g., by sending data via an application programming interface (API) for processing by an application executing on the client device 160). As described herein, a user may provide a natural language prompt instead of interacting with a traditional user interface. The application server 130A generates a system prompt for an LLM provided by the LLM server 140. The system prompt describes available operations of the application. The system prompt and the user-provided prompt are provided to the LLM server 140. The LLM of the LLM server 140 responds with structured data (e.g., data in extended markup language (XML) or JSON format) that identifies one or more operations of the application and corresponding parameters. The application server 130 executes the identified operations and provides a response to the user.

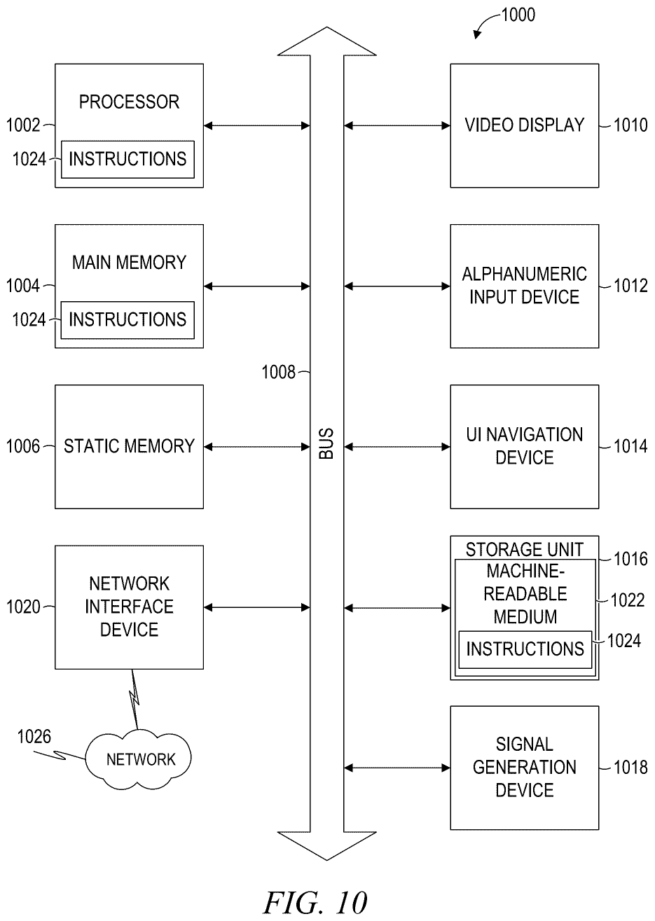

The application servers 130A-130B, the database servers 150A-150B, and the client devices 160A-160B may each be implemented in a computer system, in whole or in part, as described below with respect to FIG. 10. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one LLM server 140, two application servers 130A-130B, two client devices 160A and 160B, and the like), any number of each element is contemplated. For example, the application server 130A may be one of dozens or hundreds of active and standby servers and provide services to millions of client devices. Likewise, the LLM server 140 may be used by many application servers 130, and so on.

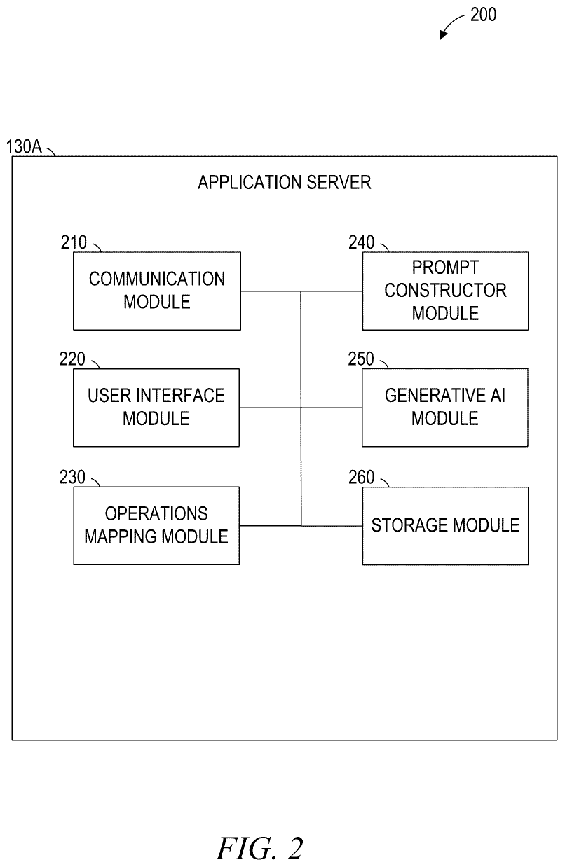

FIG. 2 shows a block diagram of the application server 130A, suitable for enhancing user interactions with applications by using generative AI. The application server 130A is shown as including a communication module 210, a user interface module 220, an operations mapping module 230, a prompt constructor module 240, a generative AI module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may receive, from the client device 160A, selections or input into fields of a user interface generated by the user interface module 220. The input may include a natural language prompt.

The user interface module 220 generates user interfaces for display on a display device of the client devices 160. For example, an HTML document may be generated and sent, via the communication module 210, to the client device 160A for rendering by a web browser.

The operations mapping module 230 maps operations of an application to a standardized format. For example, an XML document may be generated by the operations mapping module 230 with elements for available operations and their parameters.

The prompt constructor module 240 constructs a prompt for an LLM based on the mapping generated by the operations mapping module 230 and a prompt provided by a user via a user interface generated by the user interface module 220.

The generative AI module 250 includes an LLM that generates structured data in response to a prompt generated by the prompt constructor module 240. Using well-constructed prompts, a general-purpose LLM may provide high quality results without specialized training. The generated structured data may be used by the application server 130A to control operations of the application. Based on the performed operations, the user interface module 220 may generate an updated user interface for provision to the client device 160 and display to a user.

Data, metadata, documents, instructions, or any suitable combination thereof may be stored and accessed by the storage module 260. For example, local storage of the application server 130A, such as a hard drive, may be used. As another example, network storage may be accessed by the storage module 260 via the network 190.

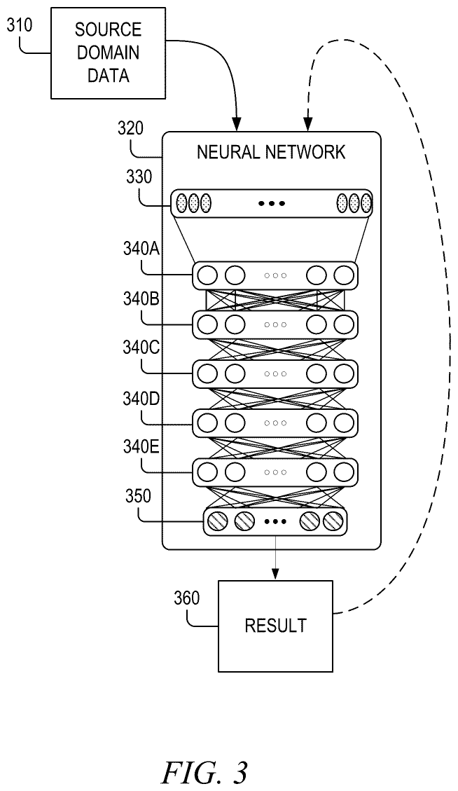

FIG. 3 is a block diagram of a neural network 320, suitable for use as a generative AI for enhancing user interactions with applications, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset, and the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value, which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on historical (existing) data (for instance, resource usage data) from the system to predict future data.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

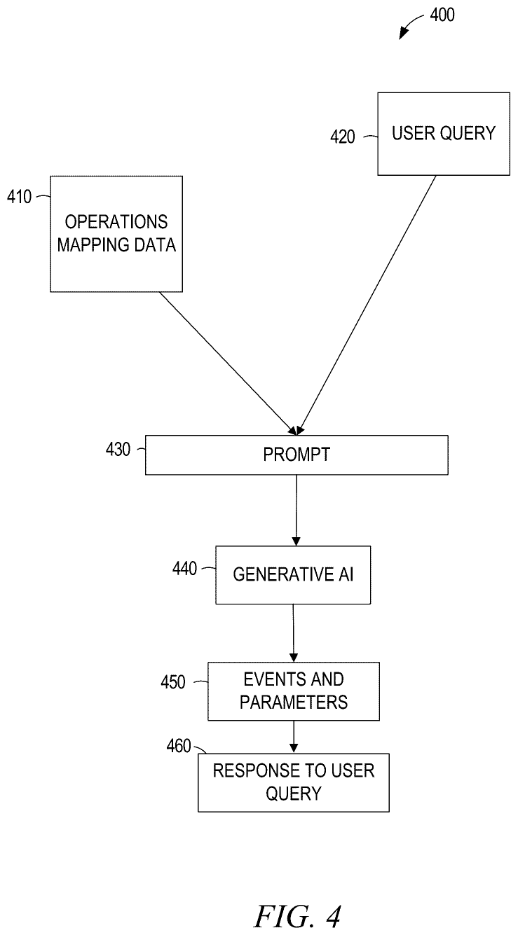

FIG. 4 illustrates a data flow 400 for a generative AI being used to enhance user interactions with an application, according to some example embodiments. Data is used to generate a prompt 430. The data used includes operations mapping data 410, a user query 420, or any suitable combination thereof. The prompt 430 is provided to a generative AI 440. In response to the prompt 430, the generative AI 440 generates events and parameters 450. Based on the events and parameters 450, the application performs operations and generates a response 460 to the user query 420.

The operations mapping data 410 identifies one or more operations that may be performed by the application. The operations mapping data 410 may include information for the identified operations, such as a description of each operation. Information for parameters of the operations may also be included, such as names, descriptions, types, or any suitable combination thereof. In some example embodiments, the operations mapping data 410 is accessed from a database, file, or data structure. The operations mapping data 410 may be provided by the application using function calls.

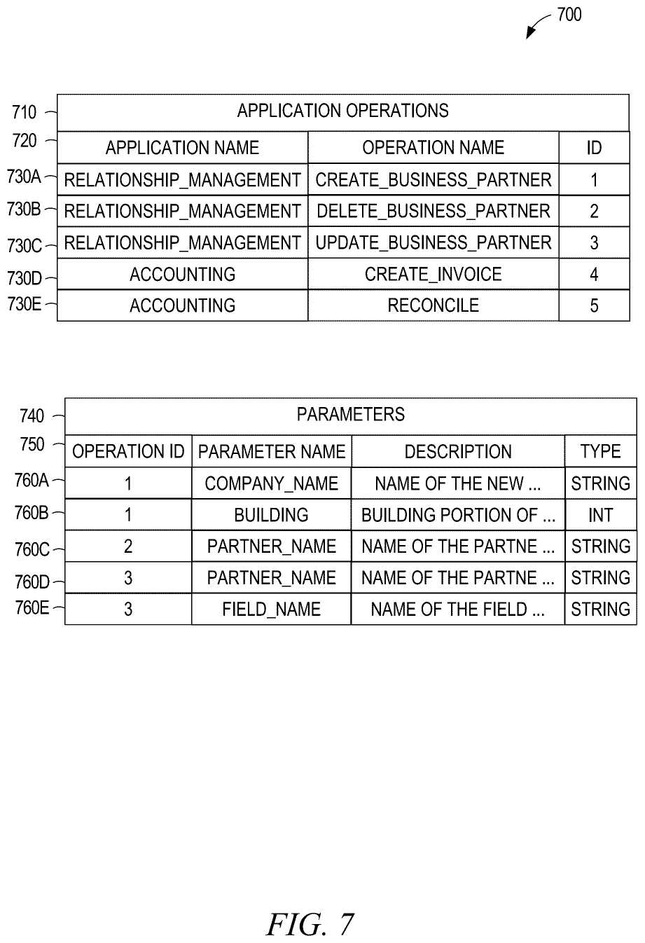

For example, data from the rows 730A-730C of FIG. 7 may be accessed to identify operations of a RELATIONSHIP_MANAGEMENT application. Additional data for the operations of the rows 730A-730C may be accessed from the parameters table 740 of FIG. 7. The data from the database schema 700 may be presented in an XML format, such as that shown below. To better illustrate a practical application, additional parameters that are not shown in FIG. 7 are included in the example XML portion below.

```
<commands>
  <command>
    <id>CREATE_BUSINESS_PARTNER</id>
    <description>Create a new business partner (BP).
</description>
    <parameters>
      <parameter>
        <id>COMPANY_NAME</id>
        <description>Company name only (without the legal
form).</description>
        <type>string</type>
      </parameter>
      <parameter>
        <id>CURRENCY_CODE</id>
        <description>Currency in code form (e.g., USD, EUR).
This parameter is typically derived from the COUNTRY parameter
(e.g., for Germany, the currency is EUR).</description>
      </parameter>
      <parameter>
        <id>EMAIL_ADDRESS</id>
        <description>Email address. If the WEB_ADDRESS parameter
is not provided, you can derive it from the email (with
“www.”).</description>
      </parameter>
      <parameter>
        <id>WEB_ADDRESS</id>
        <description>Web address. If the web address is not
provided, you can derive it from the EMAIL_ADDRESS (with
“www.”).</description>
      </parameter>
      <parameter>
        <id>BP_ROLE</id>
        <description>Business Partner (BP) role. Possible values
are 01 (for customer) or 02 (for supplier).
        </description>
      </parameter>
      <parameter>
        <id>STREET</id>
        <description>Street name.</description>
      </parameter>
      <parameter>
        <id>BUILDING</id>
        <description>Street or house number.</description>
        <type>int</type>
      </parameter>
      <parameter>
        <id>POSTAL_CODE</id>
        <description>Postal/ZIP code.</description>
      </parameter>
      <parameter>
        <id>CITY</id>
        <description>City. If COUNTRY_CODE is not provided, you
can make an educated guess based on the city.</description>
      </parameter>
      <parameter>
        <id>COUNTRY_CODE</id>
        <description>Country code (e.g., US for USA, DE for
Germany, GB for Great Britain). This parameter can be used to
derive the CURRENCY_CODE.</description>
      </parameter>
      <parameter>
        <id>PHONE_NUMBER</id>
        <description>Telephone number. If COUNTRY_CODE is not
provided, you can make an educated guess based on the phone
number.</description>
      </parameter>
      <parameter>
        <id>FAX_NUMBER</id>
        <description>Fax number.</description>
      </parameter>
    </parameters>
  </command>
  <command>
    <id>DELETE_BUSINESS_PARTNER</id>
    ...
  </command>
  ...
</commands>
```

The user may provide the user query 420 via a user interface. The user query 420 includes the user's specific request for a task to be performed. For example, the user query 420 may include particular details about an entity to be created or data being requested.

A prompt constructor (e.g., the prompt constructor module 240 of FIG. 2) uses some or all of the data to generate the prompt 430. The generated prompt is provided to the generative AI 440. An example prompt 430 is below, with the body of the <commands> structure above replaced with ellipses.

```
You are tasked to translate user prompts into commands with
parameters. Here is the mapping table of the commands in the
form of an XML:
<commands>
    ...
</commands>
Analyze the user prompt to assign the correct commands and
parameters. It is possible that your response contains more than
one command. The same command can appear more than once. Each
command may have 0 to n parameters.
Use ABAP XML Schema (asx) for your response. Here is an ABAP XML
example:
<asx:abap>
  <commands>
      <command>
        <name>COMMAND_1</name>
        <parameters>
          <parameter>
            <name>param1</name>
            <value>value for param1</value>
          </parameter>
          <parameter>
            <name>param2</name>
            <value>value for param2</value>
          </parameter>
        </parameters>
      </command>
  </commands>
</asx:abap>
Hi, we have a new customer, here are the details:
SAP KG
555 Main St.
69190 Walldorf
Telephone: +49/5555/5-55555
Fax: +49/5555/5-55556
info@sap.com
```

In the example above, everything before the line beginning with “Hi” is the system prompt. The portion of the prompt beginning with “Hi” is the user query 420. The system prompt includes, within the first <commands></commands> block, information about the available operations, derived from the operations mapping data 410. The system prompt also includes additional instructions for the generative AI 440, such as the desired output format for the response. The generative AI 440 handles the user query 420 according to the instructions provided in the system prompt.

As instructed, in response to the prompt 430, the generative AI 440 generates the events and parameters 450 (e.g., a list of operations to be performed and their parameters). An example output is shown below.

```
<asx:abap>
  <asx:values>
    <RESPONSE>
      <COMMANDS>
        <item>
          <NAME>CREATE_BUSINESS_PARTNER</NAME>
          <PARAMETERS>
            <item>
              <NAME>COMPANY_NAME</NAME>
              <VALUE>SAP</VALUE>
            </item>
            <item>
              <NAME>LEGAL_FORM</NAME>
              <VALUE>KG</VALUE>
            </item>
            <item>
              <NAME>EMAIL_ADDRESS</NAME>
              <VALUE>info@sap.com</VALUE>
            </item>
            <item>
              <NAME>BUILDING</NAME>
              <VALUE>555</VALUE>
            </item>
            <item>
              <NAME>POSTAL_CODE</NAME>
              <VALUE>69190</VALUE>
            </item>
            <item>
              <NAME>CITY</NAME>
              <VALUE>Walldorf</VALUE>
            </item>
            <item>
              <NAME>COUNTRY_CODE</NAME>
              <VALUE>DE</VALUE>
            </item>
            <item>
              <NAME>CURRENCY_CODE</NAME>
              <VALUE>EUR</VALUE>
            </item>
            <item>
              <NAME>PHONE_NUMBER</NAME>
              <VALUE>+49/5555/5-55555</VALUE>
            </item>
            <item>
              <NAME>FAX_NUMBER</NAME>
              <VALUE>+49/5555/5-55556</VALUE>
            </item>
          </PARAMETERS>
        </item>
      </COMMANDS>
    </RESPONSE>
  </asx:values>
</asx:abap>
```

In this example, the command CREATE_BUSINESS_PARTNER is performed with the indicated company_name, legal_form, email_address, building, postal_code, city, country_code, currency_code, phone_number, and fax_number parameters. Results from the command or commands are generated and the response 460 to the user query is generated and presented to the user.

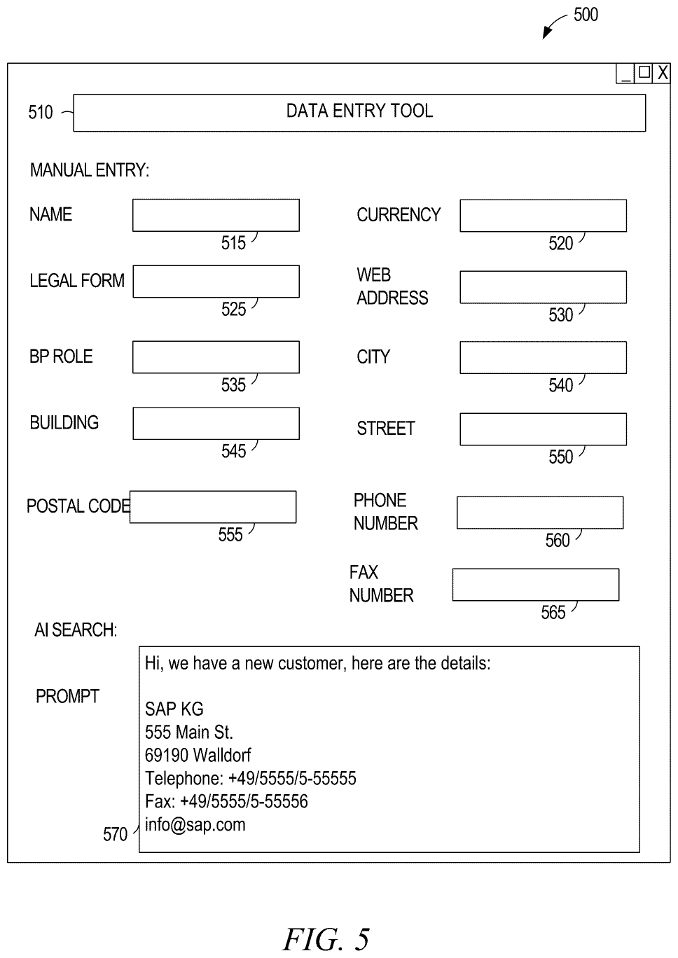

FIG. 5 shows an illustration of a user interface 500 suitable for enhanced user interaction with an application, according to some example embodiments. The user interface 500 includes a title 510 and input fields 515, 520, 525, 530, 535, 540, 545, 550, 555, 560, 565, and 570. The user interface 500 may be presented on a display of one of the client devices 160, for use by a user seeking to provide data to an application.

The title 510 indicates that the user interface 500 is for a data entry tool. The input fields 515-565 may be used for traditional data entry. The user interface 500 identifies which data is expected in each of the input fields 515-565. For correct operation of the user interface 500, the user enters the expected data into each of the input fields 515-565 and submits the data for processing by the data entry application.

The input field 570 provides an alternative input method. The user provides natural language text in the input field 570, to be processed according to the data flow 400 of FIG. 4 as the user query 420. After operations directed by the generative AI 440 of FIG. 4 are performed, the data entry task will be complete without the user having to ensure that each piece of data entered is organized according to the design choices made by the programmer that created the user interface 500 and selected the prompts for the input fields 515-565.

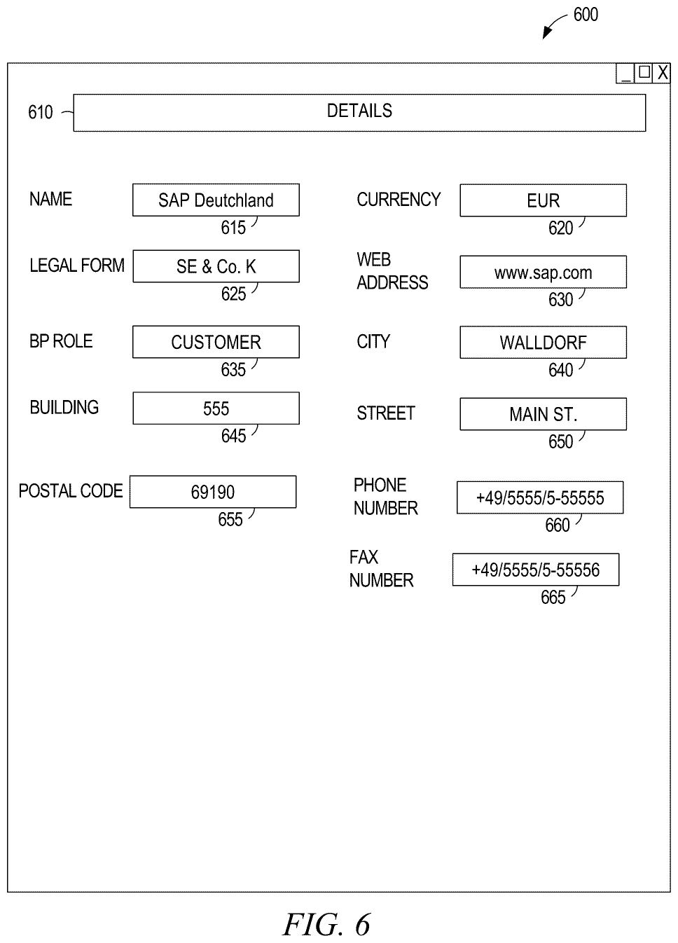

FIG. 6 shows an illustration of a user interface 600 suitable for displaying results from an application, according to some example embodiments. The user interface 600 includes a title 610 and data fields 615, 620, 625, 630, 635, 640, 645, 650, 655, 660, and 665. The user interface 600 may be presented after a user submits the natural language command shown in FIG. 5.

The title 610 indicates that the user interface 600 presents detail information for a business. The data fields 615-665 are populated with the name, currency, legal form, web address, business partner role, city, building, street, postal code, phone number, and fax number of a business. The data fields 615-665 include data in the correct fields based on the output of the generative AI 440 of FIG. 4, without the user needing to individually fill in each of the input fields 515-565 of FIG. 5.

FIG. 7 illustrates an example database schema 700, suitable for use in enhancing user interactions with applications by using generative AI. The database schema 700 includes an application operations table 710 and a parameters table 740. The application operations table 710 includes rows 730A, 730B, 730C, 730D, and 730E of a format 720. The parameters table 740 includes rows 760A, 760B, 760C, 760D, and 760E of a format 750.

Each of the rows 730A-730E identifies an operation by associating a numeric identifier with a named operation of a named application. In the example of FIG. 7, the application operations table 710 defines three operations for the RELATIONSHIP_MANAGEMENT application and two operations for the ACCOUNTING application. By way of example, only a few operations are shown for only a few applications. In practice, the application operations table 710 may include data for dozens or hundreds of applications, and each application may have dozens or hundreds of operations.

The parameters table 740 contains metadata regarding the parameters of the operations identified in the application operations table 710. The operation ID of the parameters table 740 can be cross-referenced with the ID of the application operations table 710 to access parameter metadata for a named operation of an application. For example, the rows 760A and 760B contain metadata for the CREATE_BUSINESS_PARTNER operation of the RELATIONSHIP_MANAGEMENT application by virtue of the matching ID values of one. Each of the rows 760A-760E includes a parameter name, a description of the parameter, and a type of the parameter (e.g., integer, string, double, long, float, array, or any suitable combination thereof).

In various example embodiments, more or fewer fields are stored in the application operations table 710 and the parameters table 740. For example, a default value may be stored for each parameter in the parameters table 740.

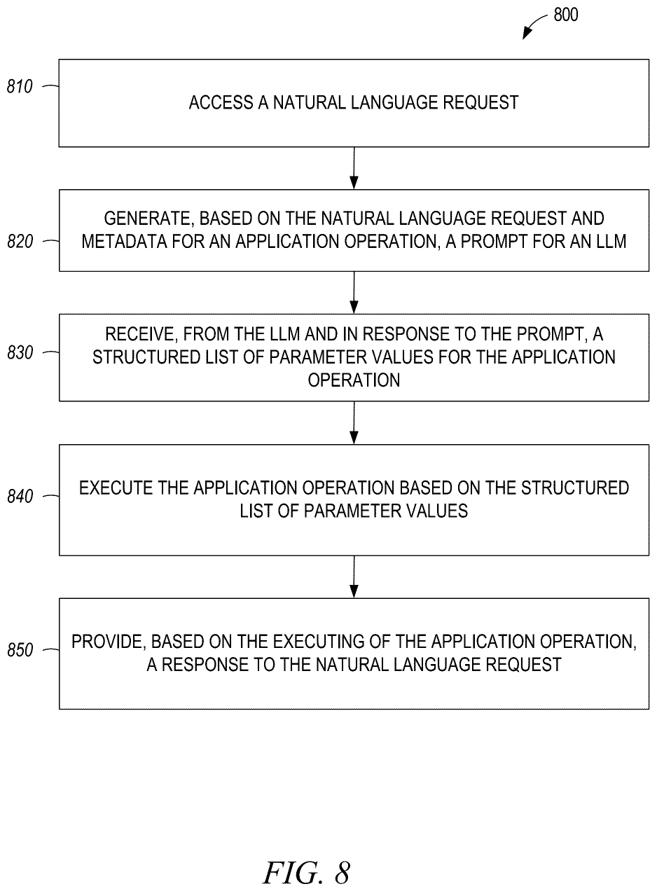

FIG. 8 illustrates a flowchart for a method 800 of enhancing user interactions with applications by using generative AI, according to some example embodiments. The method 800 includes operations 810, 820, 830, 840, and 850. By way of example and not limitation, the method 800 is described as being performed by the application server 130 of FIG. 1, using the modules of FIG. 2, the machine learning model of FIG. 3, the data flow 400 of FIG. 4, and the user interfaces of FIGS. 5 and 6.

In operation 810, the prompt constructor module 240 accesses a natural language request. For example, the natural language request may be received by the user interface module 220 and via the user interface 500 of FIG. 5. In some example embodiments, the prompt constructor module 240 also accesses a user-selected scenario. For example, prior to submitting the natural language prompt via the user interface 500, the user may select from a predetermined list of available scenarios such as create new business partner, create new invoice, modify invoice, and the like.

The prompt constructor module 240, in operation 820, generates, based on the natural language request and metadata for an application operation, a prompt for an LLM. The prompt may include a system prompt portion and a user prompt portion. The system prompt portion is based, at least in part, on the metadata for the application operation. The prompt for the LLM may be based on metadata for multiple operations. The user prompt portion is based, at least in part, on the natural language request. The system prompt portion may include instructions to the LLM for a structured format to use to generate output. The system prompt portion, the user prompt portion, or both may be based on the user-selected scenario. For example, the operations used to generate the system prompt may be selected based on the user-selected scenario (e.g., by looking up the operations to use in a database table in which the scenario is a primary key).

The metadata for the application operation may include an identifier of the application operation, a description of the application operation, parameter metadata, or any suitable combination thereof. The parameter metadata may include, for each parameter of the application operation, a name of the parameter, a type of the parameter, a description of the parameter, or any suitable combination thereof. The prompt for the LLM may be based on metadata for multiple application operations.

In operation 830, the application server 130A receives, from the LLM and in response to the prompt, a structured list of parameter values for the application operation. For example, the response to the prompt may include a set of parameter values in XML format. The list of parameter values for the application operation may be part of a larger data structure that identifies multiple application operations and their parameters.

The application server 130A executes the application operation based on the structured list of parameter values, in operation 840. In operation 850, the application server 130A provides, based on the executing of the application operation, a response to the natural language request. For example, results from the performed operation may be presented, in a user interface, to a user that submitted the natural language request. Thus, by use of the method 800, a user is enabled to interact with an application using a natural language interface.

Prior to performance of the method 800, the application server 130A may store data for all operations of an application into the application operations table 710 and the parameters table 740, both of FIG. 7. Accordingly, the generation of the prompt in operation 820 may be based on the stored data from the database. Including a description of each parameter of each available operation may assist the LLM in determining which operations to invoke and the appropriate parameter values for the selected operations.

In view of the above-described implementations of subject matter this application discloses the following list of examples. One feature of an example in isolation or more than one feature of an example, taken in combination and, optionally, in combination with one or more features of one or more further examples are further examples also falling within the disclosure of this application.

Example 1 is a system for recommending data assets, the system comprising: a memory that stores instructions; and one or more processors coupled to the memory and configured to execute the instructions to perform operations comprising: accessing a natural language request; generating, based on the natural language request and metadata for an operation, a prompt for a large language model (LLM); receiving, from the LLM and in response to the prompt, a structured list of parameter values; and providing, based on the structured list of parameter values, a response to the natural language request.

In Example 2, the subject matter of Example 1, wherein the generating of the LLM prompt is further based on a user-selected scenario.

In Example 3, the subject matter of Examples 1-2, wherein the operations further comprise: storing data for an operation of an application into a database table; and based on the structured list of parameter values, invoking the operation.

In Example 4, the subject matter of Example 3, wherein the storing of the data for the operation comprises storing a parameter name and a parameter type.

In Example 5, the subject matter of Examples 3-4, wherein the storing of the data for the operation comprises storing a parameter description and a parameter default value.

In Example 6, the subject matter of Examples 1-5, wherein the response from the LLM comprises a set of parameter values in extended markup language (XML) format.

In Example 7, the subject matter of Examples 1-6, wherein the operations further comprise: receiving, via a user interface, the natural language request.

Example 8 is a non-transitory computer-readable medium that stores instructions that, when executed by one or more processors, cause the one or more processors to perform operations comprising: accessing a natural language request; generating, based on the natural language request and metadata for an operation, a prompt for a large language model (LLM); receiving, from the LLM and in response to the prompt, a structured list of parameter values; and providing, based on the structured list of parameter values, a response to the natural language request.

In Example 9, the subject matter of Example 8, wherein the generating of the LLM prompt is further based on a user-selected scenario.

In Example 10, the subject matter of Examples 8-9, wherein the operations further comprise: storing data for an operation of an application into a database table; and based on the structured list of parameter values, invoking the operation.

In Example 11, the subject matter of Example 10, wherein the storing of the data for the operation comprises storing a parameter name and a parameter type.

In Example 12, the subject matter of Examples 10-11, wherein the storing of the data for the operation comprises storing a parameter description and a parameter default value.

In Example 13, the subject matter of Examples 8-12, wherein the response from the LLM comprises a set of parameter values in extended markup language (XML) format.

In Example 14, the subject matter of Examples 8-13, wherein the operations further comprise: receiving, via a user interface, the natural language request.

Example 15 is a method comprising: accessing, by one or more processors, a natural language request; generating, based on the natural language request and metadata for an operation, a prompt for a large language model (LLM); receiving, from the LLM and in response to the prompt, a structured list of parameter values; and providing, based on the structured list of parameter values, a response to the natural language request.

In Example 16, the subject matter of Example 15, wherein the generating of the LLM prompt is further based on a user-selected scenario.

In Example 17, the subject matter of Examples 15-16 includes storing data for an operation of an application into a database table; and based on the structured list of parameter values, invoking the operation.

In Example 18, the subject matter of Example 17, wherein the storing of the data for the operation comprises storing a parameter name and a parameter type.

In Example 19, the subject matter of Examples 17-18, wherein the storing of the data for the operation comprises storing a parameter description and a parameter default value.

In Example 20, the subject matter of Examples 15-19, wherein the response from the LLM comprises a set of parameter values in extended markup language (XML) format.

Example 21 is an apparatus comprising means to implement any of Examples 1-20.

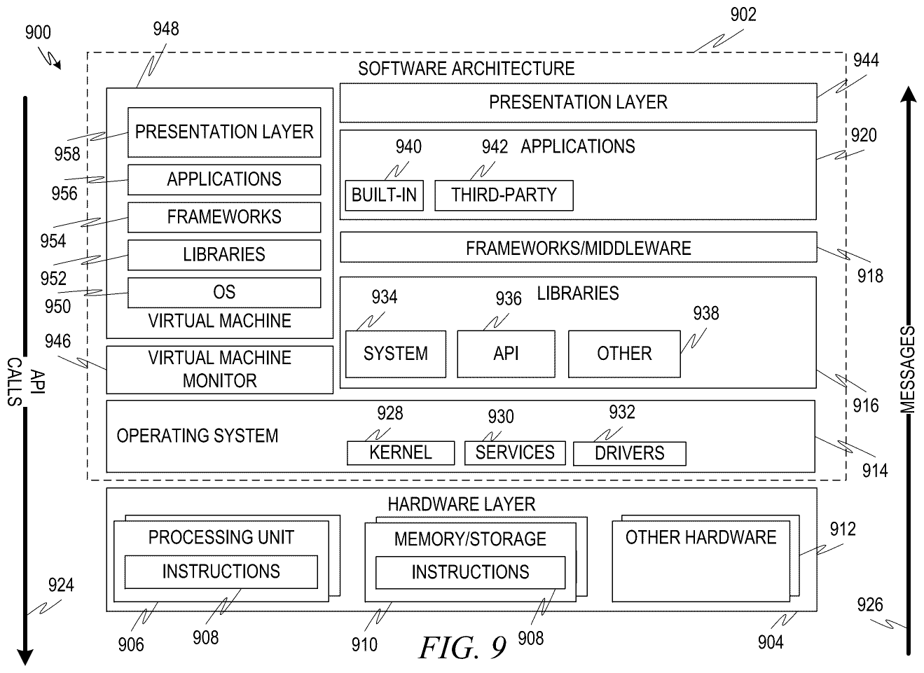

FIG. 9 shows a block diagram 900 showing one example of a software architecture 902 for a computing device. The software architecture 902 may be used in conjunction with various hardware architectures, for example, as described herein. FIG. 9 is merely a non-limiting example of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware 912 which represents any other hardware of the hardware layer 904. Examples of the other hardware 912 include the hardware components shown in FIG. 10.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke API calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 10 shows a block diagram of a machine in the example form of a computer system 1000 within which instructions 1024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit [CPU], a graphics processing unit [GPU], or both), a main memory 1004, and a static memory 1006, which communicate with each other via a bus 1008. The computer system 1000 may further include a video display unit 1010 (e.g., a liquid crystal display [LCD] or a cathode ray tube [CRT]). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting a machine-readable medium 1022.

While the machine-readable medium 1022 is shown in FIG. 10 to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with the instructions 1024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system for recommending data assets, the system comprising:
a memory that stores instructions; and
one or more processors coupled to the memory and configured to execute the instructions to perform operations comprising:
accessing a natural language request;
generating, based on the natural language request and metadata for an application operation, a prompt for a large language model (LLM);
receiving, from the LLM and in response to the prompt, a structured list of parameter values;
executing the application operation based on the structured list of parameter values; and
providing, based on the executing of the application operation, a response to the natural language request.

2. The system of claim 1, wherein the generating of the LLM prompt is further based on a user-selected scenario.

3. The system of claim 1, wherein the operations further comprise:
storing data for the application operation into a database table; and
based on the structured list of parameter values, invoking the application operation.

4. The system of claim 3, wherein the storing of the data for the application operation comprises storing a parameter name and a parameter type.

5. The system of claim 3, wherein the storing of the data for the application operation comprises storing a parameter description and a parameter default value.

6. The system of claim 1, wherein the response from the LLM comprises a set of parameter values in extended markup language (XML) format.

7. The system of claim 1, wherein the operations further comprise:
receiving, via a user interface, the natural language request.

8. A non-transitory computer-readable medium that stores instructions that, when executed by one or more processors, cause the one or more processors to perform operations comprising:
accessing a natural language request;
generating, based on the natural language request and metadata for an application operation, a prompt for a large language model (LLM);
receiving, from the LLM and in response to the prompt, a structured list of parameter values;
executing the application operation based on the structured list of parameter values; and
providing, based on the executing of the application operation, a response to the natural language request.

9. The non-transitory computer-readable medium of claim 8, wherein the generating of the LLM prompt is further based on a user-selected scenario.

10. The non-transitory computer-readable medium of claim 8, wherein the operations further comprise:
storing data for the application operation into a database table; and
based on the structured list of parameter values, invoking the application operation.

11. The non-transitory computer-readable medium of claim 10, wherein the storing of the data for the application operation comprises storing a parameter name and a parameter type.

12. The non-transitory computer-readable medium of claim 10, wherein the storing of the data for the application operation comprises storing a parameter description and a parameter default value.

13. The non-transitory computer-readable medium of claim 8, wherein the response from the LLM comprises a set of parameter values in extended markup language (XML) format.

14. The non-transitory computer-readable medium of claim 8, wherein the operations further comprise:
receiving, via a user interface, the natural language request.

15. A method comprising:
accessing, by one or more processors, a natural language request;
generating, based on the natural language request and metadata for an application operation, a prompt for a large language model (LLM);
receiving, from the LLM and in response to the prompt, a structured list of parameter values;
executing the application operation based on the structured list of parameter values; and
providing, based on the executing of the application operation, a response to the natural language request.

16. The method of claim 15, wherein the generating of the LLM prompt is further based on a user-selected scenario.

17. The method of claim 15, further comprising:
storing data for the application operation into a database table; and
based on the structured list of parameter values, invoking the application operation.

18. The method of claim 17, wherein the storing of the data for the application operation comprises storing a parameter name and a parameter type.

19. The method of claim 17, wherein the storing of the data for the application operation comprises storing a parameter description and a parameter default value.

20. The method of claim 15, wherein the response from the LLM comprises a set of parameter values in extended markup language (XML) format.
